(19) United States
(12) Patent Application Publication
(10) Pub. No.: US 2002/0027690 A1
(43) Pub. Date: Mar. 7, 2002

(54) Fiber optic transceiver employing analog dual loop compensation

(76) Inventors: Meir Bartur, Los Angeles, CA (US); Farzad Ghadooshahy, Brentwood, CA (US); Sean Zargari, Woodland Hills, CA (US); Jim Stephenson, Thousand Oaks, CA (US)

Correspondence Address: David L. Henty, Myers, Dawes & Andras LLP, Suite 1150, 19900 MacArthur Blvd., Irvine, CA, 92612, US

(21) Appl. No.: 09/907,232

(22) Filed: Jul. 17, 2001

Related U.S. Application Data
(60) Provisional application No. 60/230,134, filed on Sep. 5, 2000.

(51) Int. Cl. H04J 14/08; H04B 10/00

(52) U.S. Cl. 359/152; 359/135

(57) ABSTRACT

A fiber optic transmitter and/or transceiver adapted for use in an optical fiber data transmission system which is capable of transmitting data at high data rates in burst mode is disclosed. An analog dual loop automatic power control circuit samples monitored laser power peak and valley levels and uses them for modulation and bias laser driver control. These levels compensate for variations in laser power due to temperature variations or other factors. The sampled peak and valley levels are held between bursts in an analog level memory and are reestablished on a burst by burst basis. The optical transmitter or transceiver is further capable of operating in both burst and continuous modes.

### RELATED APPLICATION INFORMATION

The present application claims priority under 35 USC 119 (e) of provisional application Ser. No. 60/230,134 filed Sep. 5, 2000 the disclosure of which is incorporated herein by reference.

### BACKGROUND OF THE INVENTION

1. Field of the Invention

The present invention relates to fiber optic transmitters and receivers and related optical networking systems and methods of transmitting and receiving data along optical networking systems.

2. Background of the Prior Art and Related Information

Fiber optic data distribution networks are becoming increasingly important for the provision of high bandwidth data links to commercial and residential locations. Such systems employ optical data transmitters and receivers (or “transceivers”) throughout the fiber optic distribution network. Depending on the specific implementation of the fiber optic network the optical transceivers may operate in a continuous mode or in a burst mode. Also, depending on the specific architecture of the fiber optic network a given receiver may be coupled to receive data from one or a relatively large number of individual transmitters.

Referring to FIGS. 1A and 1B, typical continuous mode and burst mode data transmission patterns are illustrated, respectively. As illustrated in FIG. 1A, in a typical continuous mode data transmission pattern the modulated optical power levels correspond to the encoded data. For example, NRZ (Non Return to Zero) encoding is common in fiber optic distribution networks. In the example of FIG. 1, a high optical power level corresponds to a “1” while a low optical power level corresponds to a “0”, as illustrated in the diagram. Various other encoding techniques may be employed, however, as will be appreciated by those skilled in the art. In any case, in continuous mode transmission the power level corresponding to a high signal will be relatively constant, or at least relatively slowly varying, over time. This allows the receiver to lock onto the optical power levels corresponding to the high and low signals and allows the receiver to relatively easily discriminate the encoded data from the modulated light pulses. Continuous mode transmission may typically be employed where a fiber is not shared by two transmitters or where wavelength division multiplexing is employed to share a fiber.

In FIG. 1B, a representative burst mode data pattern is illustrated corresponding to first and second data bursts provided from the transmitter of a single transceiver. As illustrated a typical data burst or packet comprises a relatively short, high density burst of data. Each burst is typically followed by a relatively long period during which the transmitter is asleep, before the next data burst. During this sleep period another transmitter may be active on the same fiber. Such burst transmission may thus allow multiple transceivers to share an optical fiber on a time division multiple access (TDMA) basis. Also, such burst transmission may allow one receiver to be coupled to receive data from many transmitters on a time multiplexed basis, whether by sharing of a fiber or with separate fibers. For example, burst transmission may be employed in fiber optic data distribution networks which couple a central data distribution transceiver to multiple end user transceivers on a TDMA basis. Also, continuous and burst transmission may be combined in some fiber optic data distribution networks. For example, a central data distribution transceiver may transmit in a continuous mode, e.g., a cable TV signal, whereas the end user transceivers transmit in a burst mode back to the central data distribution transceiver.

Both burst mode transmission and continuous mode transmission can create difficult constraints on transmitter performance, especially at high data rates. This may be appreciated from FIGS. 1A and 1B. As shown the optical “0” level is not at zero optical power. This is necessary at high data rates since the residual charge in the transmitter laser diode prevents the optical output power from immediately going to zero when the drive current is turned off. Therefore, the 1 to 0 transition at high data rates cannot return to zero power. To distinguish a 1 from a 0 a minimum power ratio between the 1 and 0 optical power levels must be maintained, which ratio is typically referred to as the extinction ratio. For example, a minimum extinction ratio of 10 may typically be required for reliable data recovery. External factors affecting the laser power for a given current may cause the extinction ratio to change, however, potentially falling outside the acceptable range. For example, laser diode optical power output is highly temperature sensitive and ambient temperature variations and/or temperature increases as the transmitter operates may result in unacceptably large variations in the extinction ratio. Also, aging and wear of a transmitter may result in significantly different optical power being provided over time, also potentially reducing the extinction ratio below an acceptable range. These factors can result in data recovery errors or inability to meet specifications for more demanding applications.

To address this problem, feedback control of the laser diode optical power has been provided to compensate for temperature variations and effects of aging and wear. A back facet monitor photodiode is typically used to monitor laser output power and the drive current to the laser diode is adjusted to keep average optical output power relatively constant despite the above noted temperature variations and other factors. Although this can address the problem to some degree, the effect of temperature and/or aging and wear may not be the same for the 0 optical power level as the 1 level. Therefore, the extinction ratio may change despite the use of feedback control.

Dealing with the variation of the extinction ratio becomes a much more serious problem for high data rate burst transmission. As shown in FIG. 1B each transmitter is awake for a very short period of time corresponding to the transmitter's time slot in a TDMA system. When the transmitter turns on at the beginning of a burst the feedback loop employed for optical power stabilization must have time to reestablish itself. This closing of the feedback loop may take a millisecond or more. In a high capacity burst transmission TDMA network application, however, the total time slot available for the transmitter to send a burst may be less than a millisecond, for example, several microseconds. Therefore, the feedback loop never has time to close and the extinction ratio problem cannot be adequately solved in this way. Alternatively, the transmitter may be left on but at the zero level between bursts. This approach is not effective, however, since the average power during normal operation is an average of the 1 and 0 levels and cannot be stabilized at the zero level. Also, in applications employing burst transmission one receiver may be coupled to many transmitters operating in burst mode in respective time slots. If all these transmitters are left on at the zero level they may nonetheless sum to create a false high level. E.g., if the extinction ratio is 10, then 10 transmitters left on at the zero level would create a false one. Therefore, during the time period the transmitter is asleep in FIG. 1B it must turn off to zero optical power as quickly as possible.

From the above it will be appreciated that high data rate optical fiber data transmission systems present extremely difficult problems for transmitter design. In particular, burst transmission systems or combined burst and continuous systems pose particularly difficult problems for transmitter design. Also, it is extremely important to provide solutions to these problems without significantly increasing the costs of the system.

Accordingly, it will be appreciated that a need presently exists for an optical transmitter and/or transceiver capable of transmitting data at high densities in burst mode which can address the above noted problems. It will further be appreciated that a need presently exists for such an optical transmitter or transceiver which can provide such capability without added cost or complexity. It will further be appreciated that a need presently exists for an optical transmitter or transceiver capable of operating in both burst and continuous mode.

### SUMMARY OF THE INVENTION

The present invention provides an optical transmitter and/or transceiver adapted for use in an optical fiber data transmission system which is capable of transmitting data at high densities in burst mode. The present invention further provides an optical transmitter or transceiver which can provide such capability without added cost or complexity. The present invention further provides an optical transmitter or transceiver capable of operating in both burst and continuous mode.

In a first aspect the present invention provides an optical transmitter, comprising a laser diode, a laser driver having a data input for receiving input data and providing a drive signal to the laser diode corresponding to the input data, a laser diode power monitoring photodiode for monitoring the laser optical output power and providing a laser power monitoring signal, and an automatic power control circuit coupled to the laser driver and the laser diode power monitoring photodiode. The automatic power control circuit receives the laser power monitoring signal from the laser diode power monitoring photodiode and provides a power control signal to the laser driver. The automatic power control circuit comprises a peak detector for detecting peak levels of the laser power monitoring signal, an analog level memory for storing the peak levels, and a comparator for comparing the peak levels to a reference level and providing an error signal. The automatic power control circuit employs the error signal to provide the power control signal to the laser driver.

One preferred optical networking application of the transmitter is a burst mode transmission system where the transmitter transmits data bursts and the analog level memory stores the peak levels between bursts. This allows the power control to be immediately reestablished in consecutive bursts and delays associated with closing of a feedback loop are avoided. This in turn allows effective power control even for short duration bursts. Preferably the analog level memory comprises a sample and hold circuit which holds the sampled peak level between bursts.

In such an application the transmitter may receive a sleep signal between bursts. The automatic power control circuit may further comprise a timing circuit receiving the sleep signal and a selector switch coupled to the timing circuit and receiving the power control signal as an input. The selector switch outputs the power control signal to the laser driver during burst transmission and a preset low power sleep control signal to the laser driver between bursts under the control of the timing circuit. The timing circuit may further place the analog level memory in a hold state storing the peak level between bursts in response to the sleep signal.

In a further aspect the optical transmitter may include a shut-off control circuit, coupled to the automatic power control circuit, for shutting off the laser driver if the monitored laser power exceeds a preset safety level. In a preferred embodiment the shut-off control circuit may comprise a laser power monitoring circuit receiving a laser power monitoring signal from the automatic power control circuit and a shut-off circuit. The shut-off control circuit may further comprise a laser diode driver current monitoring circuit receiving the laser drive current from the laser driver and the shut-off control circuit also shuts off the laser driver if the laser drive current exceeds a preset safety level.

In a preferred embodiment the optical transmitter is implemented with a dual loop analog power control circuit. In particular, the optical transmitter comprises a laser diode and a laser driver providing a drive signal to the laser diode corresponding to input data, having a modulation level for a high data input logic level and a bias level for a low input logic level. The transmitter includes a laser diode power monitoring photodiode providing a laser power monitoring signal and an analog dual loop automatic power control circuit coupled to receive the laser power monitoring signal. The automatic power control circuit comprises a peak and valley detector for detecting peak levels of the laser power monitoring signal corresponding to the modulation level and valley levels of the laser power monitoring signal corresponding to the bias level. An analog level memory is coupled to the peak and valley detector for storing said peak levels and valley levels. A first amplifier amplifies the difference between the peak levels and a first reference level and provides a modulation error signal. A second amplifier amplifies the difference between the valley levels and a second reference level and provides a bias error signal. The automatic power control circuit controls the modulation level of the laser driver drive signal in response to the modulation error signal and controls the bias level of the laser driver drive signal in response to the bias error signal. This dual loop power control aspect of the present invention allows the modulation and bias levels to be independently controlled. This allows a desired extinction ratio to be preserved despite differing variations in bias and modulation levels.

In a further aspect, the present invention provides a burst mode optical data transmission system. The burst mode optical data transmission system comprises a plurality of transmitters providing burst mode modulated optical signals. This allows the plural transmitters to share a fiber in a TDMA manner. Each of the transmitters includes optical power monitoring means for monitoring the output optical power and analog power control means for sampling the monitored optical power and controlling the optical power based on the difference between the monitored output optical power and a reference value. The analog power control means includes analog level memory means for storing the sampled optical power level between bursts. The burst mode optical data transmission system further includes at least one optical fiber optically coupled to the transmitters and a receiver optically coupled to the fiber and receiving the burst mode modulated optical signals. Because of the effective power control of the transmitters the saturation of the receiver by multiple low level transmitter outputs in the sleep mode is avoided.

In another aspect the present invention provides a method for transmitting data over an optical network in a burst mode. The method comprises providing modulated light to an optical fiber in an optical network in a burst, the burst comprising a plurality of data bits. The method further employs monitoring the output optical power of the modulated light and sampling the monitored output optical power. The sampled monitored output optical power is compared to a reference value. An error signal is provided based on the difference between the sampled output optical power and the reference value and the optical power is controlled based on the error signal. The transmitter is placed in a low power sleep mode after transmission of the burst and the sampled output optical power is stored until transmission of the next burst.

Accordingly, it will be appreciated that the present invention provides an optical transmitter and/or transceiver adapted for use in an optical fiber data transmission system which is capable of transmitting data at high densities in burst mode. Further features and advantages will be appreciated from a review of the following detailed description of the invention.

### BRIEF DESCRIPTION OF THE DRAWINGS

FIGS. 1A and 1B are optical power vs. timing diagrams illustrating typical continuous and burst mode data transmission waveforms.

FIG. 2 is a block schematic drawing of a dual fiber fiber optic data transmission system in accordance with the present invention.

FIG. 3 is a block schematic drawing of a single fiber fiber optic data transmission system in accordance with the present invention.

FIG. 4 is a block schematic drawing of a transceiver coupled to dual optical fibers in accordance with the present invention.

FIG. 5 is a block schematic drawing of a transceiver coupled to a single optical fiber in accordance with the present invention.

FIG. 6 is a block schematic drawing of an analog automatic power control circuit employed in the optical transmitter of the present invention.

FIG. 7 is a block schematic drawing of an alternate embodiment of the optical transmitter of the present invention employing an automatic shut off circuit.

FIGS. 8A and 8B are a block schematic drawing of an alternate embodiment of the optical transmitter of the present invention employing an analog automatic power control circuit and an automatic shut off circuit.

### DETAILED DESCRIPTION OF THE INVENTION

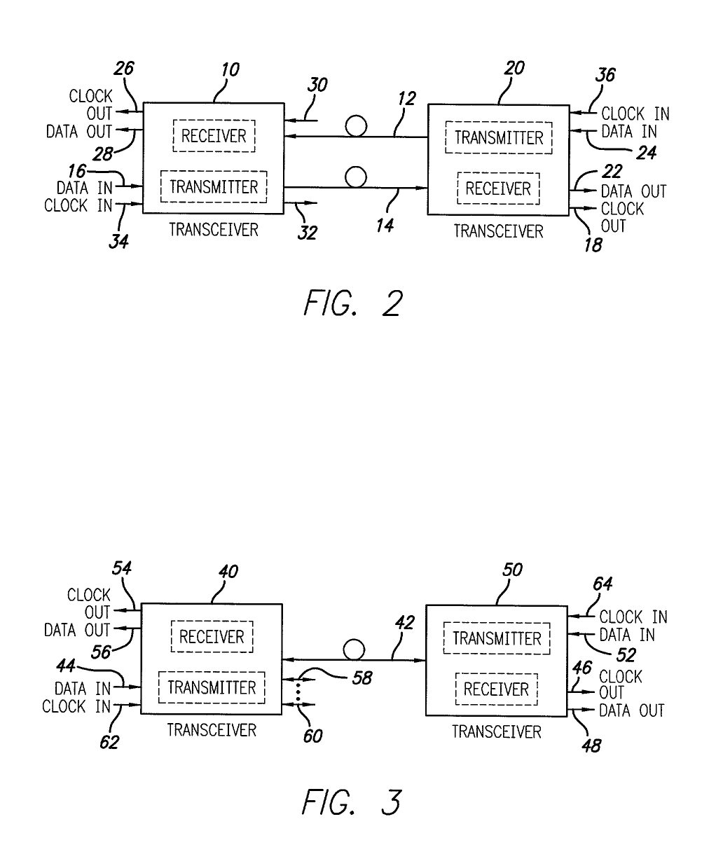

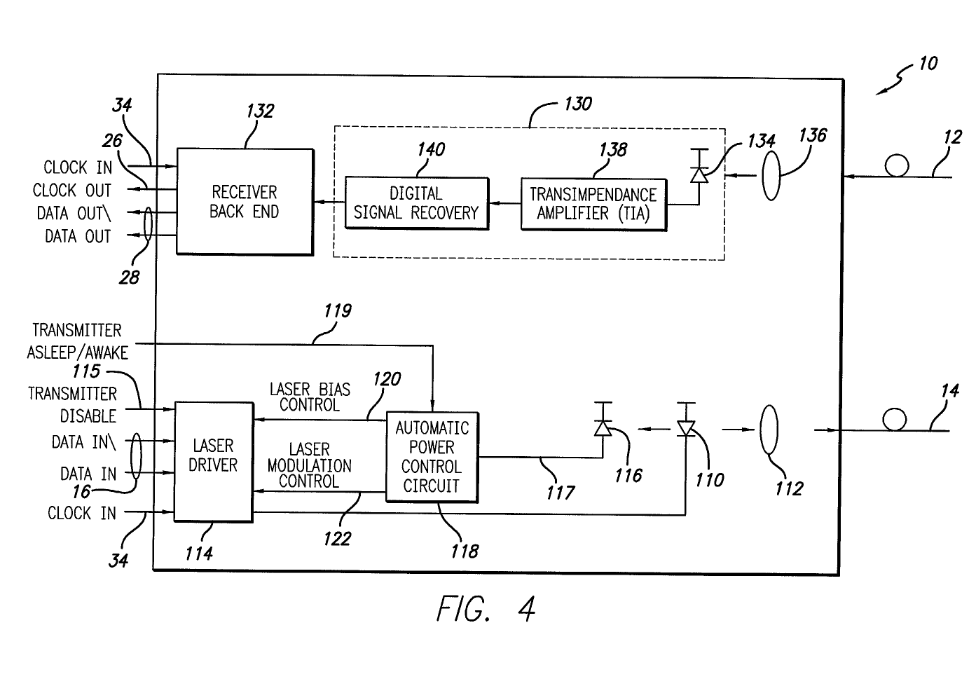

Referring to FIGS. 2 and 3, a high-level block schematic drawing of a fiber optic data transmission system incorporating the present invention is illustrated. FIG. 2 corresponds to a dual fiber data transmission system while FIG. 3 corresponds to a single fiber data transmission system.

Referring first to FIG. 2, a first transceiver 10 is coupled to a second transceiver 20 via first and second optical fibers 12 and 14. As indicated by the arrows on the optical fibers, transceiver 10 transmits data to transceiver 20 in the form of modulated optical light signals along optical fiber 14. The data to be transmitted may be provided to transceiver 10 from an external data source in the form of input electrical data signals along line 16. Transceiver 20 in turn converts the modulated light signals provided along fiber 14 to electrical signals and provides clock and data signals along lines 18 and 22 as illustrated in FIG. 2. Transceiver 20 also receives as an input electrical data signals along line 24 and transmits the data along fiber 12 in the form of modulated light signals to transceiver 10. Transceiver 10 converts the received modulated light signals to electrical signals and provides output clock and data signals along lines 26 and 28, as illustrated. In synchronous systems transceivers 10 and 20 will receive a clock signal along lines 34 and 36, respectively, in which case a clock output along lines 18 and 28 is not necessary.

Both transceiver 10 and transceiver 20 include receiver circuitry to convert optical signals provided along the optical fibers to electrical signals and to detect encoded data and/or clock signals. In various applications data transmission along the optical fibers may be in burst mode or both burst and continuous modes at different times. Also, one fiber may carry data transmitted in burst mode and another in continuous mode. For example, transceiver 10 may transmit data along fiber 14 in a continuous mode whereas transceiver 20 may transmit data back to transceiver 10 along fiber 12 in a burst mode. This configuration may for example be employed in a passive optical network (PON) where transceiver 10 corresponds to an optical line terminator (OLT) whereas transceiver 20 corresponds to an optical networking unit (ONU). In this type of fiber optic data distribution network transceiver 10 may be coupled to multiple optical networking units and this is schematically illustrated by fibers 30 and 32 in FIG. 2. For a PON system, the fibers are combined external to the transceiver. The number of such connections is of course not limited to those illustrated and transceiver 10 could be coupled to a large number of separate optical networking units in a given application, and such multiple connections are implied herein. As will be better appreciated from the following discussion, the present invention provides the capability to detect data transmitted in either burst or continuous mode operation in these various fiber optic network applications.

Referring to FIG. 3, a fiber optic transmission system is illustrated employing a single fiber coupling between transceivers 40 and 50. The operation of the transceivers in FIG. 3 is similar to that described in relation to FIG. 2 with the difference that a bidirectional data transmission is provided along fiber 42. For example, wavelength division multiplexing may be employed. If wavelength division multiplexing is employed transceiver 40 may provide data transmission to transceiver 50 employing a first wavelength of light modulated and transmitted along fiber 42 and transceiver 50 may provide data along fiber 42 to transceiver 40 employing a second wavelength of light. Alternatively transmission in the two directions may be provided in accordance with time division multiplexing or using other protocols. Input electrical data signals may be provided along line 44 from outside data source to transceiver 40 for transmission to transceiver 50 as modulated light signals. Transceiver 50 in turn receives the light pulses, converts them to electrical signals and outputs clock and data signals along lines 46 and 48 respectively. Transceiver 50 similarly receives input electrical data signals along line 52, converts them to modulated light signals and provides the modulated light signals along fiber 42 to transceiver 40. Transceiver 40 receives the modulated light pulses, converts them to electrical signals and derives clock and data signals which are output along lines 54 and 56, respectively. Also, clock inputs along lines 62 and 64 may be provided in a synchronous system. As in the case of the previously described embodiment of FIG. 2, the present invention provides the capability for either burst or continuous mode operation or both at different times. Also, as in the embodiment described above, one or more of transceivers 40 and 50 may be coupled to a plurality of additional transceivers and receive or transmit data to such transceivers along additional fibers 58 and 60, as illustrated in FIG. 3. It will further be appreciated that additional fiber coupling to additional transceivers may also be provided for various applications and architectures and such are implied herein.

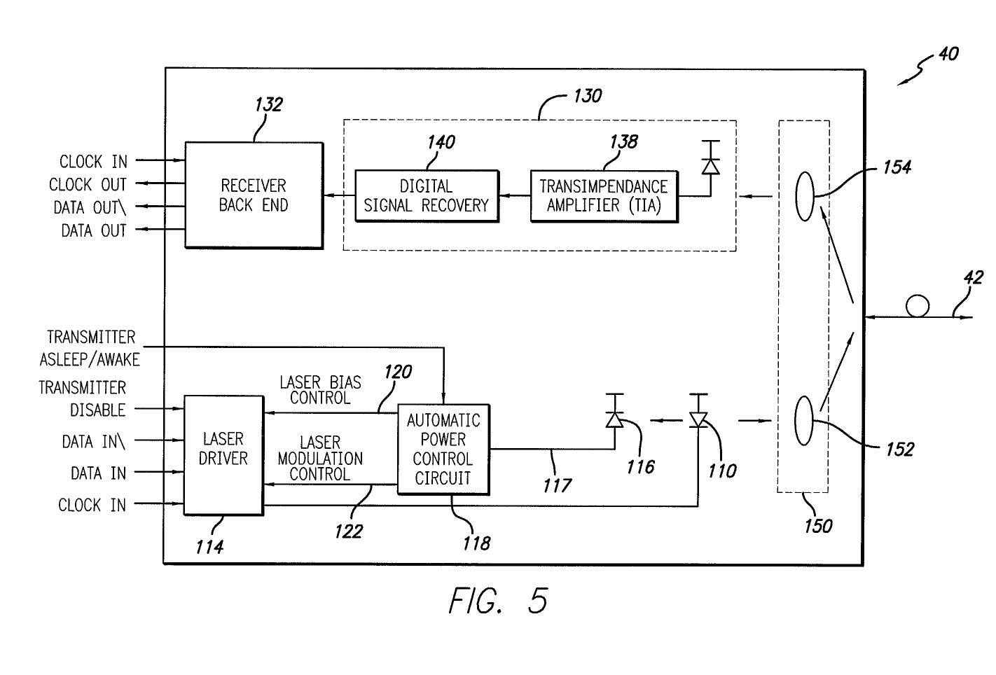

Referring to FIG. 4, a block schematic drawing of a transceiver coupled to dual optical fibers in accordance with the present invention is illustrated. The transceiver illustrated in FIG. 4 may correspond to either transceiver 10 or 20 illustrated in FIG. 2 although it is denoted by reference numeral 10 in FIG. 4 and in the following discussion for convenience of reference. The transmitter portion of transceiver 10 may operate in a continuous mode, for example, in an application where the transceiver is an OLT in a fiber optic network. Alternatively, the transmitter may operate in a burst mode, for example, if transceiver 10 is an ONU in a PON fiber optic network. Also, the transmitter may have the capability to operate in both burst and continuous modes at different times. As illustrated, the transmitter portion of transceiver 10 includes a laser diode 110 which is coupled to transmit light into optical fiber 14 via passive optical components illustrated by lens 112 in FIG. 4. Passive optical components in addition to lens 112 may also be employed as will be appreciated by those skilled in the art. Laser diode 110 is coupled to laser driver 114 which drives the laser diode in response to the data input provided along lines 16 to provide the modulated light output from laser diode 110. In particular, the laser driver provides a modulation drive current, corresponding to high data input values (or logic 1), and a bias drive current, corresponding to low data input values (or logic 0). Normally the bias drive current will not correspond to zero laser output optical power. Various modulation schemes may be employed to encode the data, for example, NRZ encoding such as described above may be employed as well as other schemes well known in the art. In addition to receiving the data provided along lines 16 the laser driver 114 may receive a transmitter disable input along line 115 as illustrated in FIG. 4. This may be used to provide a windowing action to the laser driver signals provided to the laser diode to provide a burst transmission capability in a transmitter adapted for continuous mode operation to thereby provide dual mode operation. The laser driver 114 may also receive a clock input along line 34 which may be used to reduce jitter in some applications. As further illustrated in FIG. 4, a back facet monitor photodiode 116 is preferably provided to monitor the output power of laser diode 110. The laser output power signal from back facet monitor photodiode 116 is provided along line 117 to an automatic power control circuit 118 which adjusts a laser bias control input to the laser driver 114 and a laser modulation control input to the laser driver 114, along lines 120 and 122 respectively. These control signals allow the laser driver 114 to respond to variations in laser diode output power, which power variations may be caused by temperature variations, aging of the device circuitry or other external or internal factors. This allows a minimum extinction ratio between the modulation and bias optical power levels, e.g., 10 to 1, to be maintained. To allow rapid response to the modulation and bias control signals preferably a high speed laser driver is employed. For example, a Vitesse VSC7928 laser driver or other commercially available high speed laser driver could be suitably employed for laser driver 114. A sleep/awake input may be provided along line 119 to automatic power control circuit 118 to control sleep/awake modes in burst mode transmission by controlling the modulation and bias control inputs to the laser driver 114. Depending on the particular implementation the control on line 119 may replace the disable control on line 115, or both controls may be employed.

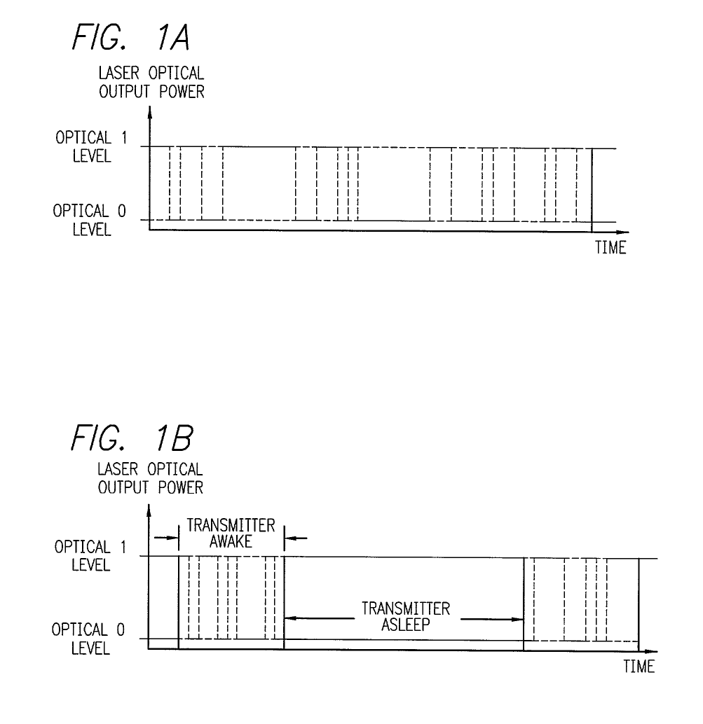

Still referring to FIG. 4, the receiver portion of the transceiver 10 includes a front end 130 and a back end 132. Front end 130 includes a photodetector 134, which may be a photodiode, optically coupled to receive the modulated light from fiber 12. Photodiode 134 may be optically coupled to the fiber 12 via passive optics illustrated by lens 136. Passive optical components in addition to lens 136 may also be employed as will be appreciated by those skilled in the art. The front end 130 of the receiver further includes a transimpedance amplifier 138 that converts the photocurrent provided from the photodiode 136 into an electrical voltage signal. The electrical voltage signal from transimpedance amplifier 138 is provided to digital signal recovery circuit 140 which converts the electrical signals into digital signals. That is, the voltage signals input to the digital signal recovery circuit from transimpedance amplifier 138 are essentially analog signals which approximate a digital waveform but include noise and amplitude variations from a variety of causes. The digital signal recovery circuit 140 detects the digital waveform within this analog signal and outputs a well defined digital waveform, for example, with a shape such as illustrated in FIG. 1A or 1B. A suitable digital signal recovery circuit is disclosed in co-pending U.S. patent application entitled “Fiber Optic Transceiver Employing Front End Level Control”, to Meir Bartur and Farzad Ghadooshahy, filed concurrently herewith. The digital signals output from digital signal recovery circuit 140 are provided to the back end of the receiver 132 which removes signal jitter, for example using a latch and clock signal to remove timing uncertainties, and which may also derive the clock signal from the digital signal if a clock signal is not available locally. In the latter case the receiver back end 132 comprises a clock and data recovery circuit which generates a clock signal from the transitions in the digital signal provided from digital signal recovery circuit 140, for example, using a phase locked loop (PLL), and provides in phase clock and data signals at the output of transceiver along lines 26 and 28, respectively. An example of a commercially available clock and data recovery circuit is the AD807 CDR from Analog Devices. Also, the receiver back end 132 may decode the data from the digital high and low values if the data is encoded. For example, if the digital signal input to the clock and data recovery circuit is in NRZ format, the clock and data recovery circuit will derive both the clock and data signals from the transitions in the digital waveform. Other data encoding schemes are well known in the art will involve corresponding data and clock recovery schemes. In the case of synchronous systems, such as PON optical networks, the clock may be available locally and the back end 132 aligns the phase of the incoming signal to the local clock, such that signals arriving from different transmitters and having differing phases are all aligned to the same clock. In this case the clock signals are inputs to the receiver back end from the local clock provided along line 34. A suitable clock and data phase aligner for such a synchronous application is disclosed in co-pending US patent application entitled “Fiber Optic Transceiver Employing Clock and Data Phase Aligner”, to Meir Bartur and Jim Stephenson, filed concurrently herewith.

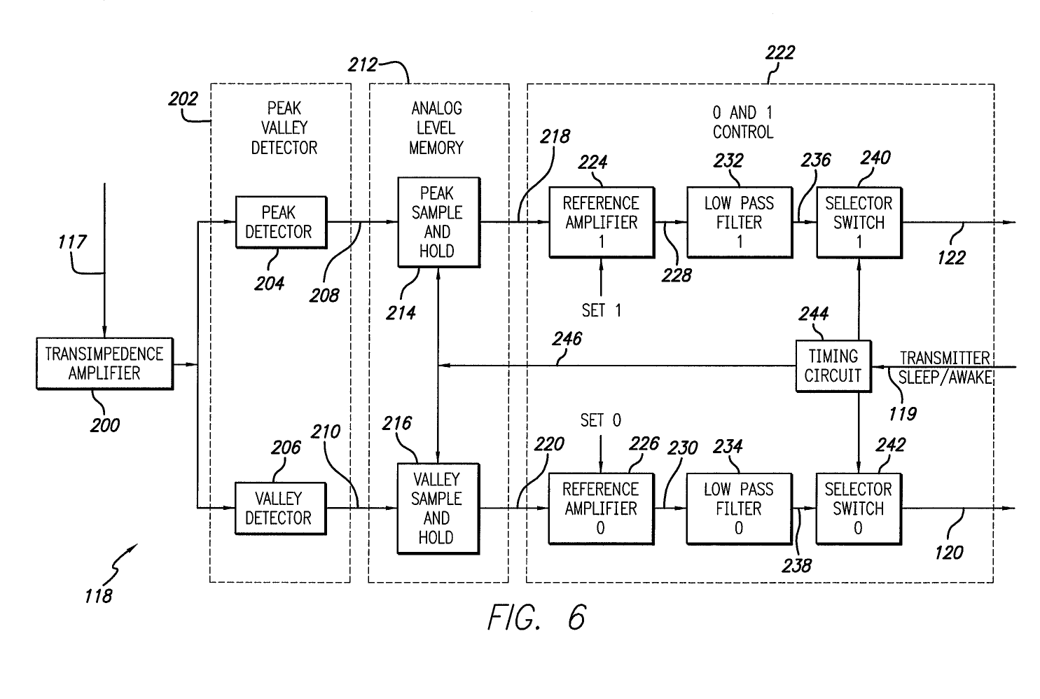

Referring to FIG. 5, transceiver 40 is illustrated corresponding to a single fiber implementation such as discussed above in relation to FIG. 3. The single fiber transceiver 40 includes the same general functional elements as described in relation to transceiver 10 above and like numerals are employed. The single fiber embodiment of FIG. 5 differs from the embodiment of FIG. 4 in that it employs optics 150 adapted to deliver modulated light to fiber 42 from the transmitter portion of transceiver 40 and to provide incoming modulated light from fiber 42 to the receiver portion. The optics 150 is generally illustrated schematically in FIG. 5 by first and second lenses 152,154, however, optics 150 may include filters and beams splitters to separate the wavelengths of light corresponding to the transmit and receive directions in a wavelength division multiplexing implementation of the single fiber transceiver. In a time division multiple access implementation of the single fiber transceiver employing a single wavelength of light, optics 150 may simply include the lenses or other optics to optically couple both the transmit laser diode and the receive photodiode to fiber 42.

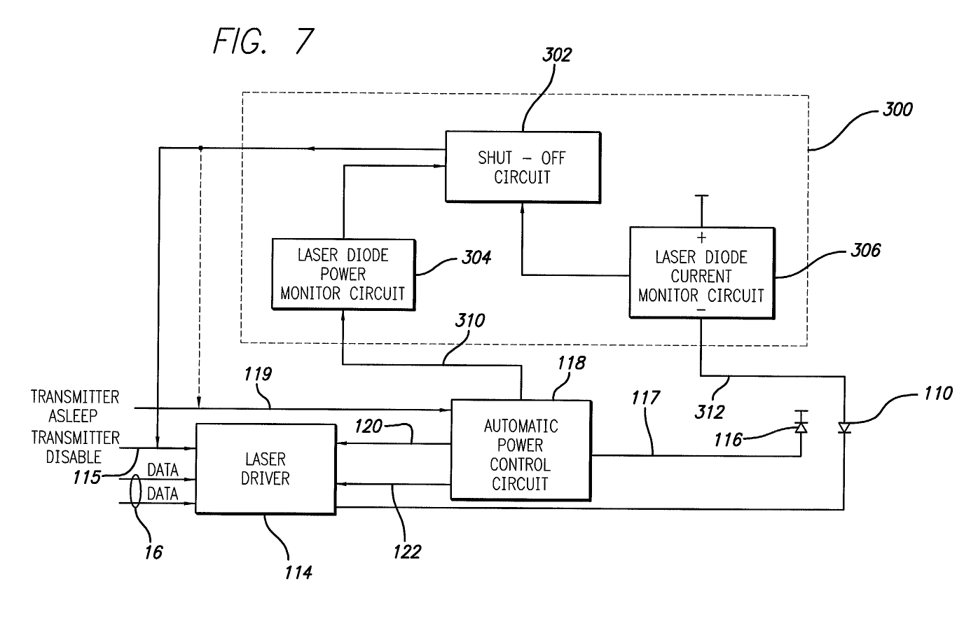

Referring to FIG. 6, a block schematic drawing of a preferred embodiment of the automatic power control circuit of the transmitter portion of the transceiver of the present invention is illustrated. The automatic power control circuit 118 provides compensation of laser bias and modulation levels and provides for analog storage of the values, i.e., the ability to remember and store the values. This allows the laser driver to rapidly recover from on/off operational modes and at the same time to compensate for temperature related variations in laser output power or other variations caused by external factors or internal factors. This allows the extinction ratio to be maintained over time without impairing the ability of the transmitter to rapidly turn on and off to thereby allow high data rate burst transmission.

Referring to FIG. 6, the automatic power control circuit 118 receives the laser power monitoring photocurrent along line 117 from the back facet photodiode 116 (illustrated in FIGS. 4 and 5). This monitoring photocurrent is provided to Transimpedance Amplifier 200 which converts the photocurrent to a voltage. The voltage level from the output of the Transimpedence Amplifier 200 is used by Peak and Valley Detector 202 to detect the equivalent peak and valley voltages to the logic levels 1 and 0 (or modulation and bias levels) of the laser's optical output levels. Peak and Valley Detector 202 may therefore comprise a peak detector 204 and a valley detector 206 which receive the output of the Transimpedence Amplifier 200 and detect the peak and valley voltages and provide the corresponding voltages on lines 208, 210, respectively. The two outputs of the Peak and Valley Detector 202 are provided to Analog Level Memory 212. The Analog Level Memory 212 comprises a Peak Sample and Hold circuit 214 and a Valley Sample and Hold circuit 216. Peak Sample and Hold circuit 214 samples and holds in its memory the voltage provided on line 208, which is the equivalent voltage level to a logic level 1 (or modulation level) of the laser's optical output. Valley Sample and Hold circuit 216 samples and holds in its memory the voltage provided on line 210, which is the equivalent voltage level to a logic level 0 (or bias level) of the laser's optical output. The outputs of Peak Sample and Hold circuit 214 and Valley Sample and Hold circuit 216 are provided along lines 218, 220, respectively.

Still referring to FIG. 6, the outputs of Peak Sample and Hold circuit 214 and Valley Sample and Hold circuit 216 along lines 218, 220 are provided to 0 And 1 Control circuit 222. 0 And 1 Control circuit 222 comprises Reference Amplifiers 224, 226 for the 1 and 0 logic levels, respectively. Reference Amplifer 224 amplifies the difference between the set reference voltage Set1, corresponding to the desired optical power of the laser for a 1 level, to the voltage level at the output of the Peak Sample and Hold circuit and generates a 1 or modulation error voltage level. Reference Amplifer 226 in turn amplifies the difference between the set reference voltage Set0, corresponding to the desired optical power of the laser for a 0 level, to the voltage level at the output of the Valley Sample and Hold circuit and generates a 0 or bias error voltage level. The Set1 and Set0 reference voltages may be from 1 and 0 reference voltage setting circuits adjusted by the user or may be values stored in a memory and output via a digital to analog converter. The 0 and 1 error output voltages are provided on lines 228, 230, respectively. The gain of the amplifiers are adjusted high enough to minimize the error but low enough to prevent loop instability. As will be appreciated by those skilled in the art, the amplifiers may be viewed as comparators with low gain and they may alternatively be referred to herein as comparators and their function may be referred to as a comparing function.

The 1 and 0 error output voltages on lines 228, 230, are provided to 1 Low Pass Filter 232 and 0 Low Pass Filter 234, respectively. 1 Low Pass Filter 232 filters the 1 error output voltage from Reference Amplifier 224 and 0 Low Pass Filter 234 filters the 0 error output voltage from Reference Amplifier 226. The filtered 1 and 0 error signals are provided along lines 236 and 238, respectively, to 1 Selector Switch 240 and 0 Selector Switch 242. 1 Selector Switch 240 switches the Laser Driver's Laser Modulation Control input on line 122 to either the output of the 1 Low Pass Filter 232 or to the Transmitter Sleep mode voltage (a voltage to reduce the laser's modulation current to a minimum possible value hence reducing the transmitter optical 1 output power level to a very low level). 0 Selector Switch 242 switches the Laser Driver's Laser Bias Control input on line 120 to either the output of the 0 Low Pass Filter 234 or to the Transmitter Sleep mode voltage (a voltage to reduce the laser's bias current to a minimum possible value hence reducing the transmitter optical power level 0 to a very low level). The Low Pass Filter reduces the loop noise and maintains loop stability. As will be appreciated by those skilled in the art, the low pass filters may be viewed as integrators with a short time constant and they may be alternatively referred to herein as integrators and their function as an integration function. Timing Circuit 244 receives a transmitter sleep/awake signal along line 119 and controls the timing for the 1 Selector Switch 240 and 0 Selector Switch 242. Timing Circuit 244 also controls the Peak Sample And Hold circuit 214 and Valley Sample And Hold Circuit 216, with a control signal along line 246 as will be discussed in detail below in relation to the circuit operation.

The operation of the transmitter portion of the transceiver will next be described in relation to FIGS. 4, 5 and 6. As stated above, the transmitter is capable of transmitting optical bursts of data of variable duration and frequency and is capable of operating in Continuous-Mode as well as Burst-Mode. The transmitter has an analog dual loop automatic power control circuit 118, a preferred embodiment of which is shown in FIG. 6, to maintain the optical power and extinction ratio of the optical data at a desired value. The Laser Driver's Laser Modulation Control input on line 122 and Laser Bias Control input on line 120 control the Optical 1 level and Optical 0 level of the laser output. By controlling these two inputs, the transmitter can be forced to a Sleep Mode between bursts, e.g., as described in relation to FIG. 1B. In Sleep Mode the output of the transmitter will be at a very low optical power level. In Awake Mode the Laser Modulation Control input 122 and Laser Bias Control input 120 are controlled by the dual analog control loops of automatic power control circuit 118. In particular, in Awake Mode, the laser's output power and extinction ratio are maintained over temperature and for degradation of the laser due to aging by automatic power control circuit 118. In order to be able to switch quickly the laser's output between Sleep Mode and Awake Mode, the laser driver needs to have a very fast response to the Laser Modulation Control input 122 and Laser Bias Control input 120. As an example, Vitesse VSC7928 Laser driver could be used in this application.

The transmitter operation could be in one of four states: (1) transmitter is in Awake Mode, (2) transmitter goes from Awake Mode to Sleep Mode, (3) transmitter is in Sleep Mode, and (4) transmitter goes from Sleep Mode to Awake Mode.

The state (1), transmitter is in Awake Mode, will first be described. In Awake Mode the dual control loops of the transmitter are in operation and monitor and regulate the output power and extinction ratio of the laser output hence providing a continuous dual closed loop operation for the transmitter. The laser's Back Facet Monitor Photodiode 116 monitors the laser's optical power level by generating a photocurrent that is proportional to this power level. Transimpedance amplifier 200 translates and amplifies the photocurrent to a voltage signal proportional to laser's output. The Peak Detector 204 generates a voltage equivalent to the peak level (1 level) of the laser's output. The Valley Detector 206 generates a voltage equivalent to the Valley level (0 level) of the laser's output. The sample and hold switches 214, 216 close in response to an awake signal along line 246 from timing circuit 244 for a dual closed loop operation. The hold circuitry is disabled by maintaining the switches closed in sample and hold circuits. Thus, Peak Sample and Hold 214 samples the peak level continuously and Valley Sample and Hold 216 samples the Valley level continuously. Thus in Awake Mode the dual feedback loop is operating continuously and the sampling circuits continuously sample the laser's 1 Level and 0 Level. The difference between the Peak and Valley voltage levels and the SET1 and SET0 reference voltages, respectively are amplified by 1 Reference Amplifier 224 and 0 Reference Amplifier 226 which generate 1 and 0 error voltages, respectively. 1 Low Pass Filter 232 and 0 Low Pass Filter 234 filter the 1 and 0 error voltages, respectively. In Awake Mode, 1 Selector Switch 240 and 0 Selector Switch 242 are selected by the Timing Circuit 244 to provide electrical connection between outputs of the Low Pass Filters and the laser driver Modulation and Bias Control inputs. Thus, the output of 1 Low Pass Filter 232 is connected through Selector Switch 240 to the laser driver Modulation Control input on line 122 and the output of 0 Low Pass Filter 234 is connected through Selector Switch 242 to the laser driver Bias Control input on line 120. Therefore a continuous dual feedback loop is established while the transmitter is in Awake Mode.

Next state (2), the transmitter goes from Awake Mode to Sleep Mode, will be described. In order for the transmitter to go from Awake Mode to Sleep Mode the following sequence of events take place. The Sleep signal input to the transmitter is activated along line 119. In response to the Sleep signal the Timing Circuit 244 generates a timing signal along line 246 to open two switches, in Peak Sample and Hold circuit 214 and Valley Sample and Hold circuit 216, respectively. This will cause the Sampling circuits to be disconnected from the Hold Circuits thereby maintaining the Peak and Valley voltages in the Analog Level Memory for the duration of the Transmitter Sleep time. Next the Timing Circuit 244 generates a signal to Selector Switch 240 and Selector Switch 242 to disconnect the output of Low Pass Filter 232 and Low Pass Filter 234 from the Laser Modulation and Bias Control inputs. The Laser modulation and Bias Control inputs of the Laser Driver are then switched by the Selector Switch 240 and Selector Switch 242 to a set voltage level to force the Laser Diode to the lowest possible output power level (Sleep Mode). In the Sleep Mode the Dual feedback loops are no longer active.

In order to reduce the amount of time required switching from one Mode to the other Mode, the Timing Circuit 244 preferably has the fastest possible components. Furthermore all the Switches preferably have very fast response times. As an example, Analog Devices part number ADG719 switches could be used for this application.

Next state (3), the transmitter is in Sleep Mode, will be described. In Sleep Mode the transmitter optical power level is maintained to the minimum possible level by maintaining the Laser Modulation and Bias Control inputs to the laser driver 114 provided on lines 122 and 120 to a pre-set low voltage level. In Sleep Mode the Analog Level Memory 212 maintains the information for the laser Modulation and Bias current levels in its memory. This allows rapid restoration of these values when the transmitter goes from Sleep Mode to Awake Mode for the next burst transmission.

Next state (4), the transmitter goes from Sleep Mode to Awake Mode will be described. In order for the transmitter to go from Sleep Mode to Awake Mode the following sequence of events take place. First the Awake signal is activated along line 119. In response, the Timing Circuit 244 sends a signal to Selector Switch 240 and Selector Switch 242 to disconnect the Laser Modulation Control input and Laser Bias Control input from the Sleep Mode pre-set voltage level. The same signal from the Timing Circuit causes the Selector Switch 240 to connect the output of Low Pass Filter 232, which contains the 1 voltage that is held in its memory from the Awake Mode, to the Laser Modulation Control input along line 122. The same signal from the Timing Circuit 244 also causes the Selector Switch 242 to connect the output of Low Pass Filter 234, which contains the 0 voltage that is held in its memory from the Awake Mode, to Laser Bias Control input along line 120. Timing circuit 244 also sends a signal on line 246 to close the two switches in Peak Sample and Hold circuit 214 and Valley Sample and Hold circuit 216, respectively. This will cause the Peak Sample and Hold circuit 214 and Valley Sample and Hold circuit 216 to begin continuously sampling again as described in the Awake mode. The timing circuit delays the turn on of the Peak Sample and Hold(214) and the Valley Sample and Hold (216) until the Peak Detector (204) and the Valley Detector (206) have stabilized, typically 50 ns.

It will be appreciated by those skilled in the art that specific circuit parameters may be adjusted for the particular application. For example, the Peak and Valley detector charge timing could be set for a particular application and is determined by the duration of the Awake Time. The Hold time of the Sample and Hold circuit could be set for a particular application and is determined by the duration of the Sleep Time. For example, for an application requiring a minimum of 1 microsecond Awake Time, the charge time for the Peak Sample circuit and Valley Sample circuit should be less than 1 microsecond. If the charge time is longer than 1 microsecond, then the Peak Sample and Valley Sample circuits will require many Awake Time cycles to stabilize. For an application requiring a maximum of 1 millisecond of Sleep Time, the discharge rate of the Peak Hold circuit and Valley Hold circuit must be several times greater than 1 millisecond. The error generated in the two feedback loops could be partly due to discharge of the Peak Hold and Valley Hold circuits during the transmitter Sleep Time. Hence it is important to reduce the charge times of Peak Sample and Valley Sample circuits so to correct the errors while dual feedback loops are closed in Awake Mode. The parameters are chosen so that the dual analog feedback loops have a very large time constant and are designed to compensate for the laser's optical output variation due to temperature changes. The loops also compensate for degradation due to aging of the laser diode. The output power and extinction ratio of the laser transmitter output levels are determined by initial factory setting of the 0 and 1 levels. These levels are set by manual setting of two potentiometers, or can be available for external control. At each power up, the transmitter at its data inputs preferably receives a pseudo-random pattern for a set period of time to acquire sampling and holding of 1 and 0 levels.

It should be appreciated that in addition to selection of various parameters and components for a particular implementation or application a variety of other modifications may be made to the above described embodiment while remaining within the scope of the invention. For example, in order to achieve zero optical power level during sleep mode, an additional control of the system may be added to disable the transmitter through a Transmitter Disable/Enable input to the laser driver along line 115 (as shown in FIG. 4). The Transmitter Disable/Enable control response time is typically slower than the Transmitter Sleep/Awake response time, however. Therefore the Transmitter Disable signal could be pre-timed to occur before the Transmitter Sleep Mode is activated to ensure zero optical power at the sleep mode timing. Where a suitably fast driver response to the modulation and bias control is available, however, the control along line 119 will typically be preferred and the enable/disable control along line 115 directly to the laser driver 114 will not be needed.

In view of the foregoing, it will be appreciated that the embodiment of the transceiver employing the automatic power control circuit of FIG. 6 provides a number of advantages. For example, separate temperature compensation for optical output levels of 1 and 0 is provided. Also, separate control for output 1 and output 0 levels enables external control of average output power and extinction ratio. Additional advantages will be appreciated by those skilled in the art.

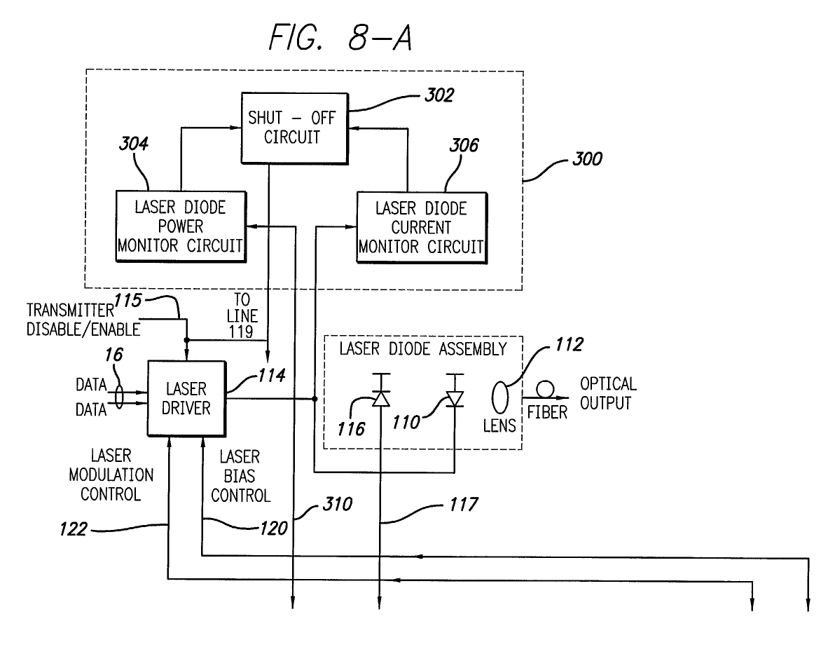

Referring to FIG. 7, an alternate embodiment of the transmitter of the present invention is illustrated employing a shut-off control circuit. The transmitter elements described previously are provided like numerals and accordingly the description thereof will not be repeated. As shown in FIG. 7, the shut-off control circuit 300 is coupled to monitor both the laser diode drive current along line 312 and the monitored laser diode power provided along line 310 from automatic power control circuit 118. The laser diode drive current could be monitored from either anode or cathode of the laser. The monitored laser diode drive current is provided to laser diode drive current monitor circuit 306 while the monitored laser data power is provided to laser diode power monitor circuit 304. Both the values are compared in the respective circuits to factory set maximum values for the laser drive current and monitored laser diode power. If either of these values exceed the factory set level a transmitter disable signal is provided to the shut-off circuit 302. This circuit provides the shut-off signal along the transmitter sleep line 119 to automatic power control circuit 118 to place the transmitter in sleep mode. When the power falls to an acceptable level the normal operation is restored by removing the sleep signal on line 119. The shut-off circuit removes power for a specific amount of time, then allows the power to be applied again. If the power is greater than the acceptable limits, the shut-off circuit will again remove power. The duty cycle of this operation is such that the average power is well below eye safety standards. Alternatively, the shut-off signal may be provided on disable line 115 to laser driver 114 or other means. In either case, this thus provides a safety stop for the transmitter preventing damage to the transmitter or other circuitry due to overdriving of the laser diode. Furthermore, the laser output may be maintained within a safety range to prevent any danger to equipment operators.

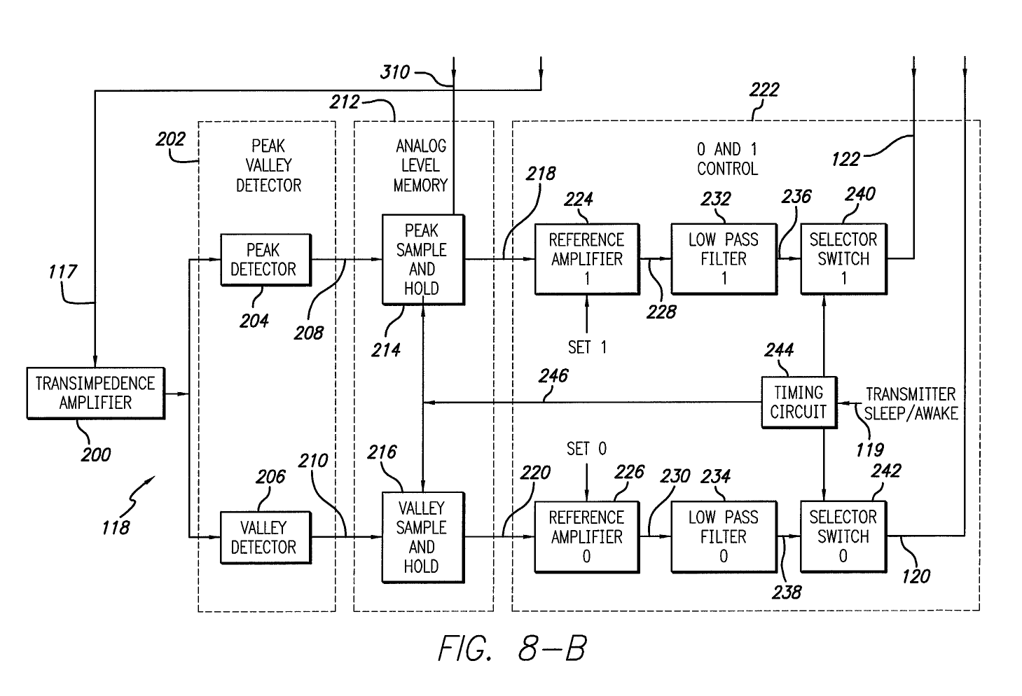

Referring to FIGS. 8A and 8B, a detailed embodiment of an optical transmitter employing the safety shutoff circuitry 300 and the automatic power control circuitry 118 is illustrated. The embodiment of FIGS. 8A and B illustrates a configuration combining the previously described embodiments and accordingly like numerals are employed and the operation thereof need not be described in detail. As illustrated in FIGS. 8A and B the laser diode power monitoring signal provided along line 310 to the laser diode power monitoring circuit may be advantageously taken from the output of the peak sample and hold circuit 214 of the automatic power control circuit 118. The output of the peak sample and hold circuit 214 is a voltage corresponding to the peak photocurrent from the back facet photodiode 116 and may therefore be employed by the laser diode power monitoring circuit 304 to detect when a maximum laser output power is exceeded.

In view of the above detailed description, it will be appreciated that the optical transmitter of the present invention allows independent control of the laser current for output 1 and output 0 conditions. Therefore, it will be appreciated that the present invention provides an optical transmitter and/or transceiver adapted for use in an optical fiber data transmission system which is capable of transmitting data at high data rates in burst mode. The present invention further provides an optical transmitter or transceiver which can provide such capability without added cost or complexity. The present invention further provides an optical transmitter or transceiver capable of operating in both burst and continuous mode.

Although the present invention has been described in relation to specific embodiments it should be appreciated that the present invention is not limited to these specific embodiments as a number of variations are possible while remaining within the scope of the present invention. In particular, the specific circuit implementations illustrated are purely exemplary and may be varied in ways too numerous to enumerate in detail. Accordingly they should not be viewed as limiting in nature.

What is claimed is:

1. An optical transmitter, comprising:
a laser diode;
a laser driver having a data input for receiving input data and providing a drive signal to the laser diode corresponding to the input data;
a laser diode power monitoring photodiode for monitoring the laser optical output power and providing a laser power monitoring signal; and
an automatic power control circuit coupled to the laser driver and the laser diode power monitoring photodiode, the automatic power control circuit receiving the laser power monitoring signal from the laser diode power monitoring photodiode and providing a power control signal to the laser driver, the automatic power control circuit comprising a peak detector for detecting peak levels of the laser power monitoring signal, an analog level memory for storing said peak levels, and a comparator for comparing the peak levels to a reference level and providing an error signal, the automatic power control circuit employing the error signal to provide the power control signal to the laser driver.

2. An optical transmitter as set out in claim 1, wherein said automatic power control circuit further comprises a transimpedance amplifier for converting the laser power monitoring signal to a voltage signal and providing the voltage signal to the peak detector.

3. An optical transmitter as set out in claim 1, wherein said analog level memory comprises a peak sample and hold circuit.

4. An optical transmitter as set out in claim 1, wherein said comparator comprises an amplifier and wherein said automatic power control circuit further comprises a low pass filter coupled to the amplifier and filtering the error signal from the amplifier and providing the filtered error signal as said power control signal.

5. An optical transmitter as set out in claim 1, wherein the transmitter transmits in data bursts and wherein said transmitter receives a sleep signal between bursts.

6. An optical transmitter as set out in claim 5, wherein said automatic power control circuit further comprises a timing circuit receiving the sleep signal and a selector switch coupled to the timing circuit and receiving the power control signal as an input, the selector switch outputting the power control signal to the laser driver during burst transmission and a preset low power sleep control signal to the laser driver between bursts under the control of the timing circuit.

7. An optical transmitter as set out in claim 1, wherein said automatic power control circuit further comprises a timing circuit receiving the sleep signal and wherein said timing circuit places said analog level memory in a hold state storing the peak level between bursts in response to the sleep signal.

8. An optical transmitter as set out in claim 7, wherein said analog level memory comprises a peak sample and hold circuit and wherein said timing circuit places said peak sample and hold circuit in a hold state in response to said sleep signal.

9. An optical transmitter as set out in claim 1, further comprising a shut-off control circuit, coupled to the automatic power control circuit, for powering down the laser driver if the monitored power exceeds a preset safety level.

10. An optical transmitter as set out in claim 9, wherein the shut-off control circuit comprises a laser power monitoring circuit receiving the peak level from the automatic power control circuit and a shut-off circuit for providing a power down control signal to the laser driver if the monitored power exceeds the preset safety level.

11. An optical transmitter as set out in claim 10, wherein said transmitter receives a sleep signal between bursts and wherein said automatic power control circuit further comprises a selector switch receiving the power control signal as an input, the selector switch outputting the power control signal to the laser driver during burst transmission and a preset low power sleep control signal to the laser driver between bursts and wherein the shut-off circuit provides the sleep signal to the automatic power control circuit if the monitored power exceeds the preset safety level.

12. An optical transmitter, comprising:
a laser diode;
a laser driver having a data input for receiving input data and providing a drive signal to the laser diode corresponding to the input data, the drive signal having a modulation level for a high data input logic level and a bias level for a low input logic level;
a laser diode power monitoring photodiode providing a laser power monitoring signal; and
an analog dual loop automatic power control circuit coupled to receive the laser power monitoring signal, the automatic power control circuit comprising:
a peak and valley detector for detecting peak levels of the laser power monitoring signal corresponding to the modulation level and valley levels of the laser power monitoring signal corresponding to the bias level,
an analog level memory coupled to the peak and valley detector for storing said peak levels and valley levels,
a first amplifier for amplifying the difference between the peak levels and a first reference level and providing a modulation error signal, and
a second amplifier for amplifying the difference between the valley levels and a second reference level and providing a bias error signal,
the automatic power control circuit controlling the modulation level of the laser driver drive signal in response to the modulation error signal and controlling the bias level of the laser driver drive signal in response to the bias error signal.

13. An optical transmitter as set out in claim 12, wherein said analog level memory comprises a peak sample and hold circuit and a valley sample and hold circuit.

14. An optical transmitter as set out in claim 12, wherein said automatic power control circuit further comprises a first low pass filter coupled to the first amplifier and filtering the error signal from the first amplifier and providing the filtered error signal to the laser driver as a modulation power control signal and a second low pass filter coupled to the second amplifier and filtering the error signal from the second amplifier and providing the filtered error signal to the laser driver as a bias power control signal.

15. An optical transmitter as set out in claim 13, wherein said transmitter transmits data in bursts and wherein said transmitter receives a sleep signal between bursts and wherein said automatic power control circuit further comprises a first selector switch coupled to the first low pass filter and receiving the modulation power control signal as an input, the first selector switch outputting the modulation power control signal to the laser driver during burst transmission and a preset low power sleep control signal to the laser driver between bursts in response to the sleep signal.

16. An optical transmitter as set out in claim 15, wherein said automatic power control circuit further comprises a second selector switch coupled to the second low pass filter and receiving the bias power control signal as an input, the second selector switch outputting the bias power control signal to the laser driver during burst transmission and a preset low power sleep control signal to the laser driver between bursts in response to the sleep signal.

17. An optical transmitter as set out in claim 12, wherein said transmitter transmits data in bursts and wherein said transmitter receives a sleep signal between bursts and wherein said automatic power control circuit further comprises a timing circuit receiving the sleep signal and wherein said timing circuit places said analog level memory in a hold state storing the peak level and valley level between bursts in response to the sleep signal.

18. An optical transceiver, comprising:
a transmitter comprising a laser diode providing modulated optical signals, a laser driver coupled to a data input and providing a drive signal to the laser diode corresponding to the input data, a laser diode power monitoring photodiode providing a laser power monitoring signal, and analog power control means for sampling and holding the laser power monitoring signal, comparing the sampled laser power monitoring signal to a reference value to derive an error signal, and controlling the laser driver based on the error signal; and
a receiver comprising a front end coupled to receive input modulated light from an optical fiber and providing a corresponding digital electrical signal and a back end coupled to receive the digital electrical signal and provide output clock and data signals.

19. A burst mode optical data transmission system, comprising:
a plurality of transmitters providing burst mode modulated optical signals, each of said transmitters including optical power monitoring means for monitoring the output optical power and analog power control means for sampling the monitored optical power and controlling the optical power based on the difference between the monitored output optical power and a reference value, the analog power control means including analog level memory means for storing the sampled optical power level between bursts;
at least one optical fiber optically coupled to the transmitters; and
a receiver optically coupled to the fiber and receiving the burst mode modulated optical signals.

20. A method for transmitting data over an optical network in a burst mode, comprising:
providing modulated light to an optical fiber in a burst, the burst comprising a plurality of data bits;
monitoring the output optical power of the modulated light;
sampling the monitored output optical power;
comparing the sampled optical power to a reference value;
providing an error signal based on the difference between the sampled optical power and the reference value;
controlling the transmitted optical power based on the error signal;
placing the transmitter in a low power sleep mode after transmission of the burst; and
storing the sampled optical power level until transmission of the next burst.
